(19) United States
(12) Patent Application Publication
(10) Pub. No.: US 2019/0272570 A1
(43) Pub. Date: Sep. 5, 2019

(54) METHOD, DEVICE, AND APPARATUS FOR GENERATING A DIFFERENTIAL ELECTRONIC BLUE INVOICE, AND READABLE STORAGE MEDIUM

(71) Applicant: Ping An Technology (Shenzhen) Co., Ltd., Shenzhen, Guangdong (CN)

(72) Inventor: Zhiyong DING, Shenzhen, Guangdong (CN)

(73) Assignee: Ping An Technology (Shenzhen) Co., Ltd., Shenzhen, Guangdong (CN)

(21) Appl. No.: 16/308,479

(22) PCT Filed: Feb. 10, 2018
(86) PCT No.: PCT/CN2018/076159

§ 371 Date: Dec. 9, 2018

(30) Foreign Application Priority Data
May 5, 2017 (CN) 201710315375.0

(51) Int. Cl. G06Q 30/04; G06Q 20/14

(52) U.S. Cl. CPC G06Q 30/04; G06Q 20/14

(57) ABSTRACT

Disclosed are a method, a device, and an apparatus for generating a differential electronic blue invoice, as well as a readable storage medium. The method includes: in response to detection of a refund request and that a full-amount electronic blue invoice has been generated during the payment process, detecting whether the refund request is a partial refund; if the refund request is a partial refund, performing a full-amount red-voiding operation based on the full-amount electronic blue invoice to obtain the remaining paid fee, and cancelling the full-amount electronic blue invoice; and generating the differential electronic blue invoice based on the remaining paid fee.

The present application claims priority to Chinese Patent Application No. 201710315375.0, filed on May 5, 2017 with the State Intellectual Property Office and entitled “Method and Device for Generating a Differential Electronic Blue Invoice, and Computer-readable Storage Medium”, the entirety of which is hereby incorporated herein by reference.

### TECHNICAL FIELD

The present application relates to the technical field of finance, and more particularly relates to a method, a device, and an apparatus for generating a differential electronic blue invoice, as well as a readable storage medium.

### BACKGROUND

Existing value-added tax (VAT) invoices are generally paper invoices. With the development of the society, electronic invoices will replace paper invoices. The current billing system only supports the generation of full-amount electronic blue invoices. When a customer performs a refunding operation, the user's paper blue invoice will be taken back. Alternatively, a full-amount electronic blue invoice will be cancelled, and then a differential red invoice will be generated. In other words, after the blue invoice has been red-voided, the blue invoice voucher would be withdrawn such that the user would no longer hold the blue invoice voucher (a blue invoice is a regular invoice, so that invoices issued to customers for settlement purposes after the sale of goods or provision of labor are all blue invoices; a red invoice is used for voiding an incorrect blue invoice or for settlement of a discounted portion of a sale).

### SUMMARY

It is therefore a primary purpose of the present application to provide a method, a device, and an apparatus for generating a differential electronic blue invoice, as well as a readable storage medium, to solve the technical problem of how to generate a differential electronic blue invoice after the customer requests for a partial refund.

To achieve the above objective, the present application provides a method for generating a differential electronic blue invoice, the method includes the following operations: when detecting a refund request and that a full-amount electronic blue invoice has been generated during the payment process, detecting whether the refund request is a partial refund; if the refund request is a partial refund, performing a full-amount red-voiding operation based on the full-amount electronic blue invoice to obtain a remaining paid fee, and cancelling the full-amount electronic blue invoice; and generating the differential electronic blue invoice based on the remaining paid fee.

In some embodiments, the method further includes the following operations prior to the block of “generating the differential electronic blue invoice based on the remaining paid fee”: calling a preset differential electronic blue invoice generation interface, detecting in the differential electronic blue invoice generation interface a first generation request for generating the differential electronic blue invoice that corresponds to the refund request, and detecting whether there already exists in the differential electronic blue invoice generation interface a second generation request that is not executed; if the first generation request is detected and the second generation request exists in the differential electronic blue invoice generation interface, then discarding the second generation request, and detecting, based on the first generation request, whether a red-voiding item corresponding to the full-amount red-voiding operation satisfies preset conditions; and if the red-voiding item satisfies the preset conditions, initiating the generation process of the differential electronic blue invoice.

In some embodiments, the method further includes the following operations subsequent to the block of “calling a preset differential electronic blue invoice generation interface, detecting in the differential electronic blue invoice generation interface a first generation request for generating the differential electronic blue invoice that corresponds to the refund request, and detecting whether there already exists in the differential electronic blue invoice generation interface a second generation request that is not executed”: if the first generation request is not detected and the second generation request does not exist in the differential electronic blue invoice generation interface, then prohibiting the operation of generating the differential electronic blue invoice based on the remaining paid fee.

In some embodiments, the method further includes the following operations subsequent to the block of “calling a preset differential electronic blue invoice generation interface, detecting in the differential electronic blue invoice generation interface a first generation request for generating the differential electronic blue invoice that corresponds to the refund request, and detecting whether there already exists in the differential electronic blue invoice generation interface a second generation request that is not executed”: if the first generation request and the second generation request are both detected but the second generation request has been executed, then obtaining a corresponding blue invoice number of the generated differential electronic blue invoice, and displaying the blue invoice number.

In some embodiments, the block of “detecting whether the red-voiding item corresponding to the full-amount red-voiding operation satisfies the preset conditions” includes the following operations: detecting whether each of the corresponding fields of the red-voiding item is a non-empty field; detecting whether the length of each field satisfies a preset length; and detecting whether each field is a mandatory field.

In some embodiments, the block of “generating the differential electronic blue invoice based on the remaining paid fee” includes the following operations: generating a differential electronic blue invoice billing item based on the remaining paid fee; and calling a preset billing interface and generating the differential electronic blue invoice based on the differential electronic blue invoice billing item.

In some embodiments, the method further includes the following operations subsequent to the block of “generating the differential electronic blue invoice based on the remaining paid fee”: obtaining a blue invoice number, a billing amount, and a billing date of the differential electronic blue invoice; and transmitting the blue invoice number, the billing amount, and the billing date to a mobile terminal.

In some embodiments, the block of “performing a full-amount red-voiding operation based on the full-amount electronic blue invoice to obtain a remaining paid fee” includes the following operations: obtaining a billed item of the full-amount electronic blue invoice and the red-voiding item corresponding to the full-amount red-voiding operation; and if the billed item has been red-voided by the red-voiding item, subtracting the corresponding amount of the red-voiding item from the corresponding amount of the billed item to obtain the remaining paid fee.

In addition, in order to achieve the above object, the present application further provides an apparatus for generating a differential electronic blue invoice, the apparatus including: a detection module configured to, in response to detection of a refund request and that a full-amount electronic blue invoice has been generated during the payment process, detection whether the refund request is a partial refund; an execution module configured to perform a full-amount red-voiding operation based on the full-amount electronic blue invoice to obtain a remaining paid fee if the refund request is a partial refund, and cancel the full-amount electronic blue invoice; and a generation module configured to generate the differential electronic blue invoice based on the remaining paid fee.

In addition, in order to achieve the above object, the present application further provides a device for generating a differential electronic blue invoice, the device including a memory, a processor, and a differential electronic blue invoice generation program that is stored in the memory and that is operable on the processor, the differential electronic blue invoice generation program when executed by the processor performing the operations of the above-described method for generating a differential electronic blue invoice.

In addition, in order to achieve the above object, the present application further provides a computer-readable storage medium having stored therein a differential electronic blue invoice generation program, which when executed by a processor performs the operations of the above-described for generating a differential electronic blue invoice.

According to this application, when detecting a refund request and that a full-amount electronic blue invoice has been generated during the payment process, a detection is performed as to whether the refund request is a partial refund. If the refund request is a partial refund, then a full-amount red-voiding operation is performed based on the full-amount electronic blue invoice to obtain the remaining paid fee, and the full-amount electronic blue invoice is additionally cancelled. Thereby, the differential electronic blue invoice is generated based on the remaining paid fee. Thus, after the customer requests for a partial refund, the full-amount blue invoice can be red-voided in full before a differential electronic blue invoice is generated. As such, the customer can still hold the electronic blue invoice voucher after making a partial refund, and the invoice generation cost can also be saved.

### BRIEF DESCRIPTION OF THE ACCOMPANYING DRAWINGS

FIG. 1 is a schematic diagram illustrating the structure of a device in terms of hardware operating environment involved in the solutions embodied in the embodiments according to the present application.

FIG. 2 is an illustrative flowchart of a first embodiment of a method for generating a differential electronic blue invoice in accordance with the present application.

FIG. 3 is an illustrative flowchart of a second embodiment of a method for generating a differential electronic blue invoice in accordance with the present application.

FIG. 4 is an illustrative flowchart of a third embodiment of a method for generating a differential electronic blue invoice in accordance with the present application.

Various implementations, functional features, and advantages of this application will now be described in further detail in connection with embodiments and the accompanying drawings.

### DETAILED DESCRIPTION OF ILLUSTRATIVE EMBODIMENTS

It will be appreciated that the embodiments described herein are merely illustrative of the present application and are not intended to limit the application.

The solution of the embodiments in accordance with the present application is primarily as follows. When detecting a refund request and that a full-amount electronic blue invoice has been generated during the payment process, a detection is performed as to whether the refund request is a partial refund. If the refund request is a partial refund, then a full-amount red-voiding operation is performed based on the full-amount electronic blue invoice to obtain the remaining paid fee, and the full-amount electronic blue invoice is additionally cancelled. Thereby, the differential electronic blue invoice is generated based on the remaining paid fee. This is intended to solve the problem of how to generate a differential electronic blue invoice after the customer request for a partial refund and to save the invoice generation cost.

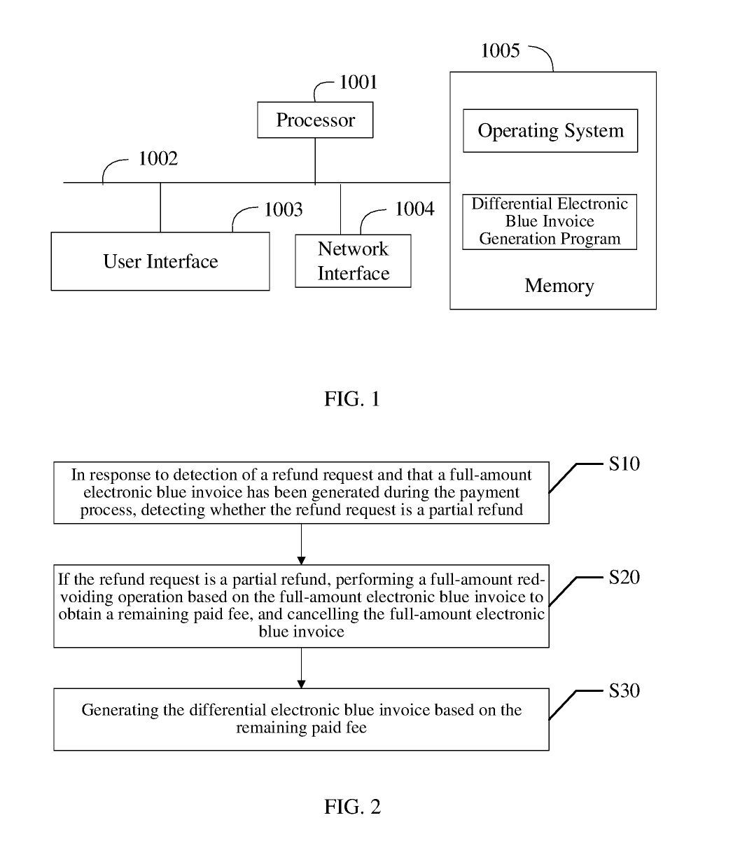

FIG. 1 is a schematic diagram illustrating the structure of a device in terms of hardware operating environment involved in the solutions embodied in the embodiments according to the present application.

The device for generating a differential electronic blue invoice (hereinafter also interchangeably referred to as a differential electronic blue invoice generation device) may be a personal computer (PC), or may also be a terminal device equipped with display functionality, such as a smart phone, a tablet computer, an e-book reader, an MP3 (Moving Picture Experts Group Audio Layer III) player, a MP4 (Moving Picture Experts Group Audio Layer IV) player, a portable computer, and so on.

As illustrated in FIG. 1, the differential electronic blue invoice generation device may include a processor 1001 (e.g., a CPU), a network interface 1004, a user interface 1003, a memory 1005, and a communication bus 1002. The communication bus 1002 is configured to facilitate connection and communication between these components. The user interface 1003 may include a display, an input unit such as a keyboard, and the user interface 1003 may optionally include a standard wired interface and wireless interface. The network interface 1004 may optionally include a standard wired interface, and a wireless interface (such as a WI-FI interface). The memory 1005 may be a high-speed RAM memory, or a non-volatile memory such as a disk memory. The memory 1005 optionally may also be a storage device that is separate from the processor 1001 described above.

Optionally, the differential electronic blue invoice generation device may further include a camera, an RF (Radio Frequency) circuitry, a sensor, an audio circuitry, a WiFi module, and the like.

Those skilled in the art will appreciate that the structure of the differential electronic blue invoice generation device illustrated in FIG. 1 does not constitute a limitation on the terminal. Therefore, the differential electronic blue invoice generation device may include more or less components than those illustrated, or some components may be combined, or different arrangements of components may be employed.

As illustrated in FIG. 1, the memory 1005 as a computer storage medium may include an operating system and a differential electronic blue invoice generation program. The operating system is a program that manages and controls the hardware and software resources of the differential electronic blue invoice generation device, and supports the operation of the differential electronic blue invoice generation program and other software and/or programs.

In the differential electronic blue invoice generation device illustrated in FIG. 1, the network interface 1004 is primarily used for connecting to a document system, a mobile terminal, etc., for performing data communication with the document system and the mobile terminal. The user interface 1003 is mainly used for detecting a refund request, a generation request, and the like. The processor 1001 can be used to call the differential electronic blue invoice generation program stored in the memory 1005 and perform the operations of the method for generating a differential electronic blue invoice (hereinafter also interchangeably referred to as a differential electronic blue invoice generation method).

The specific implementations of the differential electronic blue invoice generation device according to this application are substantially the same as the following embodiments of the differential electronic blue invoice generation method, and so they are not to be detailed herein.

Based on the hardware configuration described above, various embodiments of the differential electronic blue invoice generation method are proposed herein.

As illustrated in FIG. 2, there is depicted an illustrative flowchart of a first embodiment of a method for generating a differential electronic blue invoice in accordance with the present application.

In this embodiment, an embodiment of the differential electronic blue invoice generation method is provided. It should be noted that although a logical order is shown in the flowchart, in some cases, the steps shown or described may be performed in a different order than that.

The differential electronic blue invoice generation method includes the following blocks S10 to S30.

In S10, the method includes: when detecting a refund request and that a full-amount electronic blue invoice has been generated during the payment process, detecting whether the refund request is a partial refund.

When a customer's refund request is detected, a detection is performed as to whether the customer has generated a full-amount electronic blue invoice during the payment process. If the customer has generated a full-amount electronic blue invoice during the payment process, then a further detection is performed as to whether the refund request is a partial refund. It will be appreciated that when the corresponding amount of the refund request is equal to the amount of the full-amount electronic blue invoice, it indicates a full refund. Otherwise if the amount of the refund request is less than the amount of the full-amount electronic blue invoice, then it indicates a partial refund.

In this embodiment, the customer's identification information can be based on to detect whether the customer has generated a full-amount electronic blue invoice during the payment process, where the identification information can be the customer's identity number, contact information, or the like. In this embodiment, identification information may be added to the customer who has generated a full-amount electronic blue invoice to indicate that the customer has generated a full-amount electronic blue invoice during the payment process, where the identification information can be a number 0, a letter A, and so on. Meanwhile, identification information may be added to the customer who does not generate a full-amount electronic blue invoice during the payment process, where the identification information may be a number 1, a letter B, or the like. A full-amount electronic blue invoice is an invoice issued to the purchaser after the sale of goods, and a payment consistent with the invoice will be received after the blue invoice is issued.

Further, if the customer hasn't generated a full-amount electronic blue invoice during the payment process, then a prompt message can be output to a display interface of the differential electronic blue invoice generation device to remind the customer whether he chooses to generate a full-amount electronic blue invoice. The method then proceeds to block S20.

In S20, the method includes: if the refund request is a partial refund, performing a full-amount red-voiding operation based on the full-amount electronic blue invoice to obtain a remaining paid fee, and cancelling the full-amount electronic blue invoice.

After the refund request is determined as a partial refund, a full-amount red-voiding operation would be performed based on the full-amount electronic blue invoice so as to obtain a remaining paid fee. Meanwhile, the full-amount electronic blue invoice will be cancelled. It should be noted that in the process of revoking the full-amount electronic blue invoice, the word such as “obsolete” or “invalid” can be added to the full-amount electronic blue invoice, or an identifier indicating that the full-amount electronic blue invoice has been revoked can also be added to the full-amount electronic blue invoice.

Further, the block of “performing a full-amount red-voiding operation based on the full-amount electronic blue invoice to obtain a remaining paid fee” includes the following steps a and b.

In step a, the block includes: obtaining a billed item of the full-amount electronic blue invoice and the red-voiding item corresponding to the full-amount red-voiding operation.

In step b, the block includes: if the billed item has been red-voided by the red-voiding item, subtracting the corresponding amount of the red-voiding item from the corresponding amount of the billed item to obtain the remaining paid fee.

In the process of performing the full-amount red-voiding operation, a billed item of the full-amount electronic blue invoice as well as a red-voiding item corresponding to the full-amount red-voiding operation is obtained, and a determination is further performed as to whether the billed item has been red-voided by the red-voiding item. If the billed item has been red-voided by the red-voiding item, then the corresponding amount of the red-voiding item would be subtracted from the corresponding amount of the billed item so as to obtain the amount of the billed item that has been red-voided. Otherwise if the billed item is not red-voided by the red-voiding item, then the corresponding amount of this billed item would remain unchanged. It can be understood that the sum of the corresponding amounts of the billed items that have been red-voided and the corresponding amounts of the billed items that are not red-voided is the remaining paid fee. The corresponding monetary amount of the red-voiding items is equal to the corresponding amount of the refund request. The monetary amount of the red-voiding items is less than the corresponding amount of the billed items. The method then continues to block S30.

In S30, the method includes: generating the differential electronic blue invoice based on the remaining paid fee.

When the remaining paid fee is obtained, the differential electronic blue invoice is generated based on the remaining paid fee. It will be appreciated that the sum of the monetary amount of the differential electronic blue invoice and the monetary amount of the red-voiding items is equal to the monetary amount of the full-amount electronic blue invoice. Relative to the full-amount electronic blue invoice, in the differential electronic blue invoice, the monetary amount of a billed item that has been red-voided is modified, while the amount of a billed item that is not red-voided remains unchanged.

Further, if the generation of the differential electronic blue invoice fails, then the reason for the failure of the generation of the differential electronic blue invoice may be recorded.

Further, block S30 may include the following steps c and d.

In step c, the block includes: generating a differential electronic blue invoice billing item based on the remaining paid fee.

In step d, the block includes: calling a preset billing interface and generating the differential electronic blue invoice based on the differential electronic blue invoice billing item.

In the process of generating the differential electronic blue invoice based on the remaining paid fee, a differential electronic blue invoice billing item is generated based on the remaining paid fee, and a preset billing interface is called to generate the differential electronic blue invoice based on the differential electronic blue invoice billing item. In this embodiment, the preset billing interface is a billing interface of a document system. With the billing interface of the document system, the differential electronic blue invoice billing items can be assembled into j son format data to meet the requirements of the billing interface. The document system is a set of foreign trade management software specially designed for foreign trade enterprises, providing comprehensive and practical support for foreign trade business processes. In other embodiments, the preset billing interface may also be an interface in other systems equipped with billing functionality.

According to this embodiment, when detecting a refund request and that a full-amount electronic blue invoice has been generated during the payment process, a detection is performed as to whether the refund request is a partial refund. If the refund request is a partial refund, then a full-amount red-voiding operation is performed based on the full-amount electronic blue invoice to obtain the remaining paid fee, and the full-amount electronic blue invoice is additionally cancelled. Thereby, the differential electronic blue invoice is generated based on the remaining paid fee. Thus, after the customer requests for a partial refund, the full-amount blue invoice can be red-voided in full before a differential electronic blue invoice is generated. As such, the customer can still hold the electronic blue invoice voucher after making a partial refund, and the invoice generation cost can also be saved.

Further, a second embodiment of the differential electronic blue invoice generation method according to the present application is proposed.

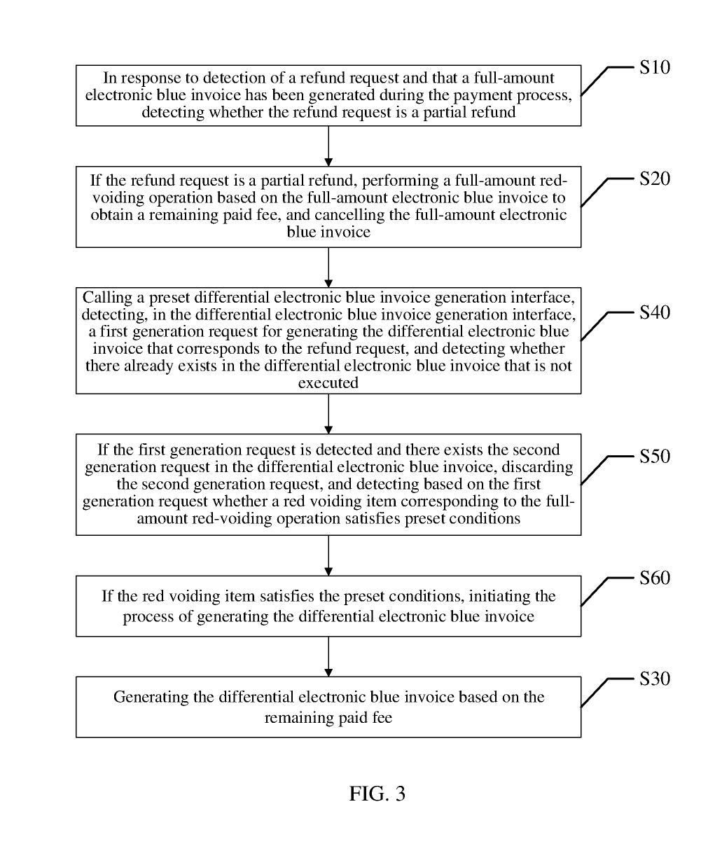

The second embodiment of the differential electronic blue invoice generation method differs from the first embodiment of the differential electronic blue invoice generation method in that the method further includes the following blocks S40 to S60, as illustrated in FIG. 3.

In S40, the method includes: calling a preset differential electronic blue invoice generation interface, detecting in the differential electronic blue invoice generation interface a first generation request for generating the differential electronic blue invoice that corresponds to the refund request, and detecting whether there already exists in the differential electronic blue invoice generation interface a second generation request that is not executed.

In S50, the method includes: if the first generation request is detected and the second generation request exists in the differential electronic blue invoice generation interface, then discarding the second generation request, and detecting, based on the first generation request, whether a red-voiding item corresponding to the full-amount red-voiding operation satisfies preset conditions.

A preset differential electronic blue invoice generation interface is called, and a detection is performed in the differential electronic blue invoice generation interface for a first generation request for generating the differential electronic blue invoice that corresponds to the refund request, and a further detection is performed as to whether there already exists in the differential electronic blue invoice generation interface a second generation request for generating the differential electronic blue invoice that has not been executed. When the first generation request is detected in the differential electronic blue invoice generation interface, and there already exists in the differential electronic blue invoice generation interface the second generation request that has not been executed, then the second generation request that is not executed would be discarded, and the detected first generation request is further based on to detect whether the red-voiding item corresponding to the full-amount red-voiding operation satisfies the preset conditions.

In this embodiment, the preset differential electronic blue invoice generation interface is an OPEN-API (Application Programming Interface). The first generation request and the second generation request may be automatically triggered by the differential electronic blue invoice generation device, or may be manually triggered by the customer, or manually triggered by the staff who operates the electronic blue invoice generation device, which however are not limited herein.

Further, the block of “detecting whether the red-voiding item corresponding to the full-amount red-voiding operation satisfies the preset conditions” includes the following step e.

In step e, the block includes: detecting whether each of the corresponding fields of the red-voiding item is a non-empty field; detecting whether the length of each field satisfies a preset length; and detecting whether each field is a mandatory field.

In the process of detecting whether the red-voiding item corresponding to the full-amount red-voiding operation satisfies the preset conditions, detections are performed as to whether each of the corresponding fields of the red-voiding item is a non-empty filed, whether the length of each field satisfies the preset length, and whether each field is a mandatory field. It should be noted that the preset lengths of the respective fields may be the same or different. When the field is detected as a non-mandatory field, then during the process of generating the differential electronic blue invoice the non-mandatory field can be set to not display on the differential electronic blue invoice. Alternatively, in the process of generating the differential electronic blue invoice, this non-mandatory field can be set to display on the differential electronic blue invoice. It should be noted that the conditions for detecting whether the red-voiding item satisfies the preset conditions include but are not limited to the above three types. In other embodiments, the preset conditions may be added, deleted, or modified according to actual needs.

For example, if the refund request is an insurance refund request, then detections are performed as to whether the fields in the red-voiding item including an accessory contract number, an insurance type code, a tax-included premium, a currency code, an exchange rate, and a converted RMB amount are non-empty fields, and whether they are mandatory fields.

In S60, the method includes: if the red-voiding item satisfies the preset conditions, initiating the generation process of the differential electronic blue invoice.

If the red-voiding item satisfies the preset conditions, then the various corresponding fields of the red-voiding item would be saved in the memory, while the process of generating the differential electronic blue invoice would be initiated at the same time, so as to perform the operation of generating a differential electronic blue invoice billing item based on the remaining paid fee.

Further, the differential electronic blue invoice generation method further includes the following block f.

In block f, the method includes: if the first generation request is not detected and the second generation request does not exist in the differential electronic blue invoice generation interface, then prohibiting the operation of generating the differential electronic blue invoice based on the remaining paid fee.

When the first generation request is not detected in the differential electronic blue invoice generation interface and the second generation request that is not executed does not exist in the differential electronic blue invoice generation interface, then the operation of generating the differential electronic blue invoice based on the remaining paid fee would be prohibited.

Further, the differential electronic blue invoice generation method further includes the following block g.

In block g, the method includes: if the first generation request and the second generation request are both detected but the second generation request has been executed, then obtaining a corresponding blue invoice number of the generated differential electronic blue invoice, and displaying the blue invoice number.

When the first generation request and the second generation request are both detected in the differential electronic blue invoice generation interface, but the second generation request has been executed in the differential electronic blue invoice generation interface, then it indicates a differential electronic blue invoice has been generated before. Thus, the corresponding blue invoice number of the generated differential electronic blue invoice is obtained and further displayed for viewing.

Further, if the first generation request is not detected in the differential electronic blue invoice generation interface, but the second generation request has been executed in the differential electronic blue invoice generation interface, then it indicates a differential electronic blue invoice has been generated before. Thus, the corresponding blue invoice number of the generated differential electronic blue invoice is obtained and further displayed for viewing.

Further, if the first generation request is not detected in the differential electronic blue invoice generation interface and the second generation request that is not executed does not exist in the differential electronic blue invoice generation interface, then a notification message may be output to trigger the generation request for generating the differential electronic blue invoice.

In this embodiment, when the first generation request is detected in the electronic blue invoice generation interface, and there already exists in the differential electronic blue invoice generation interface the second generation request that has not been executed, then the second generation request that is not executed would be discarded, and the detected first generation request is further based on to detect whether the red-voiding item corresponding to the full-amount red-voiding operation satisfies the preset conditions. This avoids the situations where the differential electronic blue invoice is repeatedly generated.

Further, a third embodiment of the differential electronic blue invoice generation method according to the present application is proposed.

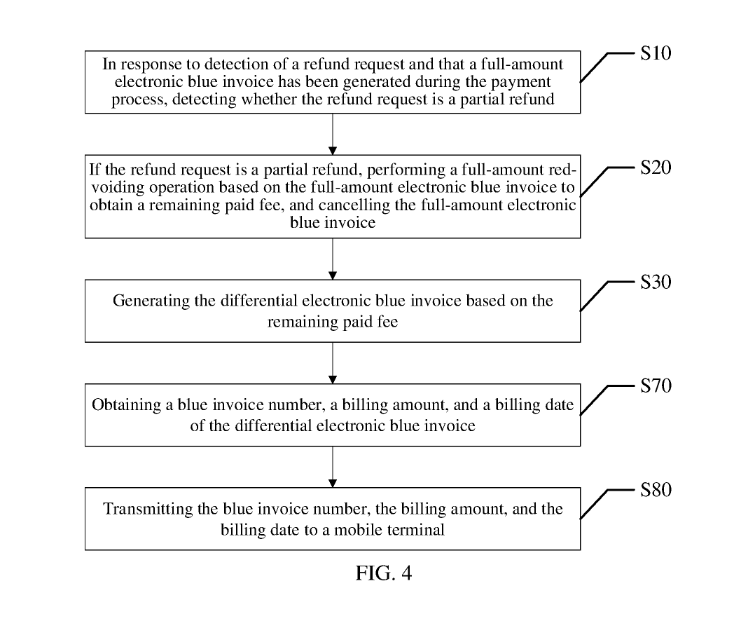

The third embodiment of the differential electronic blue invoice generation method differs from the first embodiment of the differential electronic blue invoice generation method in that the method further includes the following blocks S70 to S80, as illustrated in FIG. 4.

In S70, the method includes: obtaining a blue invoice number, a billing amount, and a billing date of the differential electronic blue invoice.

In S80, the method includes: transmitting the blue invoice number, the billing amount, and the billing date to a mobile terminal.

After generating the differential electronic blue invoice, the blue invoice number, the billing amount, and the billing date of the generated differential electronic blue invoice are obtained, and then the obtained blue invoice number, the billing amount, and the billing date are transmitted to the mobile terminal of the customer who makes the refund request, for view by the customer. It should be noted that the differential electronic blue invoice information that can be sent to the mobile terminal includes, but is not limited to, the blue invoice number, the billing amount, and the billing date, and may also include information such as a billing place, a bill receiver, and the like. In this embodiment, the mobile terminal includes without limitation a personal computer (PC), a smart phone, and a tablet computer. It will be appreciated that the blue invoice number, the billing amount, and the billing date can be transmitted to the mobile terminal by mail, short message, picture, or the like means.

According to this embodiment, after the differential electronic blue invoice is generated, the blue invoice number, the billing amount, and the billing date in the differential electronic blue invoice are transmitted to the customer's mobile terminal, thus realizing the interaction between the terminal held by the customer and the differential electronic blue invoice device, allowing the customer to learn the billing progress of the differential electronic blue invoice in real time.

Those of ordinary skill in the art will appreciate that some or all steps of the foregoing embodiments can be implemented by hardware, or can also be implemented by instructing the relevant hardware using programs. Programs can be stored in a computer readable storage medium, which can be a read-only memory, a magnetic disk, an optical disc, etc.

In addition, embodiments according to the present application further provides an apparatus for generating a differential electronic blue invoice, the apparatus including: a detection module, configured to, in response to detection of a refund request and that a full-amount electronic blue invoice has been generated during payment process, detect whether the refund request is a partial refund; an execution module, configured to perform a full-amount red-voiding operation based on the full-amount electronic blue invoice to obtain a remaining paid fee if the refund request is a partial refund, and cancel the full-amount electronic blue invoice; and a generation module, configured to generate the differential electronic blue invoice based on the remaining paid fee.

Further, the detection module is further configured to call a preset differential electronic blue invoice generation interface, detect in the differential electronic blue invoice generation interface a first generation request for generating the differential electronic blue invoice that corresponds to the refund request, and detect whether there already exists in the differential electronic blue invoice generation interface a second generation request that is not executed; the differential electronic blue invoice generation apparatus further includes a discarding module configured to discard the second generation request if the first generation request is detected and the second generation request exists in the differential electronic blue invoice generation interface; the detection module is further configured to detect, based on the first generation request, whether a red-voiding item corresponding to the full-amount red-voiding operation satisfies preset conditions; and the differential electronic blue invoice generation apparatus further includes a startup module configured to initiate the generation process of the differential electronic blue invoice if the red-voiding item satisfies the preset conditions.

Further, the differential electronic blue invoice generation apparatus further includes: an execution prohibition module configured to prohibit the operation of generating the differential electronic blue invoice based on the remaining paid fee if the first generation request is not detected and the second generation request does not exist in the differential electronic blue invoice generation interface.

Further, the differential electronic blue invoice generation apparatus further includes: a first acquisition module configured to, if the first generation request and the second generation request are both detected but the second generation request has been executed, obtain a corresponding blue invoice number of the generated differential electronic blue invoice, and display the blue invoice number.

Further, the detection module is further configured to: detect whether each of the corresponding fields of the red-voiding item is a non-empty field; detect whether the length of each field satisfies a preset length; and detect whether each field is a mandatory field.

Further, the generation module is further configured to generate a differential electronic blue invoice billing item based on the remaining paid fee, and call a preset billing interface to generate the differential electronic blue invoice based on the differential electronic blue invoice billing item.

Further, the differential electronic blue invoice generation apparatus further includes: a second acquisition module configured to obtain a blue invoice number, a billing amount, and a billing date of the differential electronic blue invoice; and a transmission module configured to transmit the blue invoice number, the billing amount, and the billing date to a mobile terminal.

Further, the execution module includes: an acquisition unit configured to obtain a billed item of the full-amount electronic blue invoice and the red-voiding item corresponding to the full-amount red-voiding operation; and an execution unit configured to, if the billed item has been red-voided by the red-voiding item, subtract the corresponding amount of the red-voiding item from the corresponding amount of the billed item to obtain the remaining paid fee.

It should be noted that the various embodiments of the differential electronic blue invoice generation apparatus are basically the same as the various embodiments of the above-described differential electronic blue invoice generation method, and so they are not to be detailed herein again.

In addition, embodiments of the present application further provides a computer-readable storage medium having stored therein a differential electronic blue invoice generation program, which when executed by a processor performs the following operations: in response to detection of a refund request and that a full-amount electronic blue invoice has been generated during payment process, detecting whether the refund request is a partial refund; if the refund request is a partial refund, performing a full-amount red-voiding operation based on the full-amount electronic blue invoice to obtain a remaining paid fee, and cancelling the full-amount electronic blue invoice; and generating the differential electronic blue invoice based on the remaining paid fee.

Further, the differential electronic blue invoice generation program when executed by the processor performs the following operations prior to the block of generating the differential electronic blue invoice based on the remaining paid fee: calling a preset differential electronic blue invoice generation interface, detecting, in the differential electronic blue invoice generation interface, a first generation request for generating the differential electronic blue invoice that corresponds to the refund request, and detecting whether there already exists in the differential electronic blue invoice generation interface a second generation request that is not executed; if the first generation request is detected and the second generation request exists in the differential electronic blue invoice generation interface, discarding the second generation request, and detecting, based on the first generation request, whether a red-voiding item corresponding to the full-amount red-voiding operation satisfies preset conditions; and if the red-voiding item satisfies the preset conditions, initiating the generation process of the differential electronic blue invoice.

Further, the differential electronic blue invoice generation program when executed by the processor performs the following operations subsequent to the block of “calling a preset differential electronic blue invoice generation interface, detecting in the differential electronic blue invoice generation interface a first generation request for generating the differential electronic blue invoice that corresponds to the refund request, and detecting whether there already exists in the differential electronic blue invoice generation interface a second generation request that is not executed”: if the first generation request is not detected and the second generation request does not exist in the differential electronic blue invoice generation interface, prohibiting the operation of generating the differential electronic blue invoice based on the remaining paid fee.

Further, the differential electronic blue invoice generation program when executed by the processor performs the following operations subsequent to the block of “calling a preset differential electronic blue invoice generation interface, detecting in the differential electronic blue invoice generation interface a first generation request for generating the differential electronic blue invoice that corresponds to the refund request, and detecting whether there already exists in the differential electronic blue invoice generation interface a second generation request that is not executed”: if the first generation request and the second generation request are both detected but the second generation request has been executed, then obtaining a corresponding blue invoice number of the generated differential electronic blue invoice, and displaying the blue invoice number.

Further, the block of “detecting whether the red-voiding item corresponding to the full-amount red-voiding operation satisfies the preset conditions” includes the following operations: detecting whether each of corresponding fields of the red-voiding item is a non-empty field; detecting whether a length of each field satisfies a preset length; and detecting whether each field is a mandatory field.

Further, the block of “generating the differential electronic blue invoice based on the remaining paid fee” includes the following operations: generating a differential electronic blue invoice billing item based on the remaining paid fee; and calling a preset billing interface and generating the differential electronic blue invoice based on the differential electronic blue invoice billing item.

Further, the differential electronic blue invoice generation program when executed by the processor performs the following operations subsequent to the block of “generating the differential electronic blue invoice based on the remaining paid fee”: obtaining a blue invoice number, a billing amount, and a billing date of the differential electronic blue invoice; and transmitting the blue invoice number, the billing amount, and the billing date to a mobile terminal.

Further, the block of “performing a full-amount red-voiding operation based on the full-amount electronic blue invoice to obtain a remaining paid fee” includes the following operations: obtaining a billed item of the full-amount electronic blue invoice and a red-voiding item corresponding to the full-amount red-voiding operation; and if the billed item has been red-voided by the red-voiding item, subtracting a corresponding monetary amount of the red-voiding item from the corresponding monetary amount of the billed item to obtain the remaining paid fee.

The specific implementations of the computer-readable storage medium of this application are basically the same as the various embodiments of the above-described differential electronic blue invoice generation method, and so they are not to be detailed herein again.

As used herein, the terms “including,” “comprising,” or any other variants thereof are intended to encompass a non-exclusive inclusion, so that processes, methods, articles, or devices that include a series of elements will include not only those elements, but also other elements as well that haven't been explicitly listed or those elements inherent in such processes, methods, articles, or devices. In the absence of further restrictions, the element defined by the phrase “including/comprising a . . . ” will not preclude the existence of additional such elements in the processes, methods, articles, or devices that include the element.

The above numbering of embodiments according to the present application is intended for illustrative purposes only, and is not indicative of the pros and cons of these embodiments.

By the above description of embodiments, it will be evident to those of skill art that the methods according to the above embodiments can be implemented by means of software plus the necessary general-purpose hardware platform; they can of course be implemented by hardware, but in many cases the former will be more advantageous. Based on such an understanding, the essential technical solution of the application, or the portion that contributes to the prior art may be embodied as software products. Computer software products can be stored in a storage medium (e.g., a ROM/RAM, a magnetic disk, an optical disk) and may include multiple instructions that, when executed, can cause a computing device (e.g., a mobile phone, a computer, a server, an air conditioner, a network device, etc.), to execute the methods as described in the various embodiments of the application.

The foregoing description merely illustrates some exemplary embodiments of the application and therefore is not intended as limiting the patentable scope of the application. Any equivalent structural or flow transformations that are made taking advantage of the application and that are used directly or indirectly in other related technical fields shall all fall in the scope of patent protection of the application.

1. A method for generating a differential electronic blue invoice, comprising:
in response to detection of a refund request and that a full-amount electronic blue invoice has been generated during payment process, detecting whether the refund request is a partial refund;
if the refund request is a partial refund, performing a full-amount red-voiding operation based on the full-amount electronic blue invoice to obtain a remaining paid fee, and cancelling the full-amount electronic blue invoice; and
generating the differential electronic blue invoice based on the remaining paid fee.

2. The method of claim 1, further comprising the following operations prior to the block of “generating the differential electronic blue invoice based on the remaining paid fee”:
calling a preset differential electronic blue invoice generation interface, detecting, in the differential electronic blue invoice generation interface, a first generation request for generating the differential electronic blue invoice that corresponds to the refund request, and detecting whether there already exists in the differential electronic blue invoice generation interface a second generation request that is not executed;
if the first generation request is detected and the second generation request exists in the differential electronic blue invoice generation interface, discarding the second generation request, and detecting, based on the first generation request, whether a red-voiding item corresponding to the full-amount red-voiding operation satisfies preset conditions; and
if the red-voiding item satisfies the preset conditions, initiating the process of generating the differential electronic blue invoice.

3. The method of claim 2, further comprising the following operations subsequent to the block of “calling a preset differential electronic blue invoice generation interface, detecting, in the differential electronic blue invoice generation interface, a first generation request for generating the differential electronic blue invoice that corresponds to the refund request, and detecting whether there already exists in the differential electronic blue invoice generation interface a second generation request that is not executed”:
if the first generation request is not detected and the second generation request does not exist in the differential electronic blue invoice generation interface, prohibiting the operation of generating the differential electronic blue invoice based on the remaining paid fee.

4. The method of claim 2, further comprising the following operations subsequent to the block of “calling a preset differential electronic blue invoice generation interface, detecting, in the differential electronic blue invoice generation interface, a first generation request for generating the differential electronic blue invoice that corresponds to the refund request, and detecting whether there already exists in the differential electronic blue invoice generation interface a second generation request that is not executed”:
if the first generation request and the second generation request are both detected but the second generation request has been executed, obtaining a corresponding blue invoice number of the generated differential electronic blue invoice, and displaying the blue invoice number.

5. The method of claim 2, wherein the block of “detecting whether a red-voiding item corresponding to the full-amount red-voiding operation satisfies preset conditions” includes the following operations:
detecting whether each of corresponding fields of the red-voiding item is a non-empty field;
detecting whether a length of each field satisfies a preset length; and
detecting whether each field is a mandatory field.

6. The method of claim 1, wherein the block of “generating the differential electronic blue invoice based on the remaining paid fee” comprises the following operations:
generating a differential electronic blue invoice billing item based on the remaining paid fee; and
calling a preset billing interface and generating the differential electronic blue invoice based on the differential electronic blue invoice billing item.

7. The method of claim 1, further comprising the following operations subsequent to the block of “generating the differential electronic blue invoice based on the remaining paid fee”:
obtaining a blue invoice number, a billing amount, and a billing date of the differential electronic blue invoice; and
transmitting the blue invoice number, the billing amount, and the billing date to a mobile terminal.

8. The method of claim 1, wherein the block of “performing a full-amount red-voiding operation based on the full-amount electronic blue invoice to obtain a remaining paid fee” comprises the following operations:
obtaining a billed item of the full-amount electronic blue invoice and a red-voiding item corresponding to the full-amount red-voiding operation; and
if the billed item has been red-voided by the red-voiding item, subtracting a corresponding monetary amount of the red-voiding item from the corresponding monetary amount of the billed item to obtain the remaining paid fee.

9. The method of claim 2, wherein the block of “performing a full-amount red-voiding operation based on the full-amount electronic blue invoice to obtain a remaining paid fee” comprises the following operations:
obtaining a billed item of the full-amount electronic blue invoice and a red-voiding item corresponding to the full-amount red-voiding operation; and
if the billed item has been red-voided by the red-voiding item, subtracting a corresponding monetary amount of the red-voiding item from the corresponding monetary amount of the billed item to obtain the remaining paid fee.

10. The method of claim 3, wherein the block of “performing a full-amount red-voiding operation based on the full-amount electronic blue invoice to obtain a remaining paid fee” comprises the following operations:
obtaining a billed item of the full-amount electronic blue invoice and a red-voiding item corresponding to the full-amount red-voiding operation; and
if the billed item has been red-voided by the red-voiding item, subtracting a corresponding monetary amount of the red-voiding item from the corresponding monetary amount of the billed item to obtain the remaining paid fee.

11. The method of claim 4, wherein the block of “performing a full-amount red-voiding operation based on the full-amount electronic blue invoice to obtain a remaining paid fee” comprises the following operations:
obtaining a billed item of the full-amount electronic blue invoice and a red-voiding item corresponding to the full-amount red-voiding operation; and
if the billed item has been red-voided by the red-voiding item, subtracting a corresponding monetary amount of the red-voiding item from the corresponding monetary amount of the billed item to obtain the remaining paid fee.

12. The method of claim 5, wherein the block of “performing a full-amount red-voiding operation based on the full-amount electronic blue invoice to obtain a remaining paid fee” comprises the following operations:
obtaining a billed item of the full-amount electronic blue invoice and a red-voiding item corresponding to the full-amount red-voiding operation; and
if the billed item has been red-voided by the red-voiding item, subtracting a corresponding monetary amount of the red-voiding item from the corresponding monetary amount of the billed item to obtain the remaining paid fee.

13. The method of claim 6, wherein the block of “performing a full-amount red-voiding operation based on the full-amount electronic blue invoice to obtain a remaining paid fee” comprises the following operations:
obtaining a billed item of the full-amount electronic blue invoice and a red-voiding item corresponding to the full-amount red-voiding operation; and
if the billed item has been red-voided by the red-voiding item, subtracting a corresponding monetary amount of the red-voiding item from the corresponding monetary amount of the billed item to obtain the remaining paid fee.

14. The method of claim 7, wherein the block of “performing a full-amount red-voiding operation based on the full-amount electronic blue invoice to obtain a remaining paid fee” comprises the following operations:
obtaining a billed item of the full-amount electronic blue invoice and a red-voiding item corresponding to the full-amount red-voiding operation; and
if the billed item has been red-voided by the red-voiding item, subtracting a corresponding monetary amount of the red-voiding item from the corresponding monetary amount of the billed item to obtain the remaining paid fee.

15. A device for generating a differential electronic blue invoice, comprising one or more processors and a non-transitory program storage medium storing program code executable by the one or more processors, the program code comprising:
a detection module, configured to, in response to detection of a refund request and that a full-amount electronic blue invoice has been generated during payment process, detect whether the refund request is a partial refund;
an execution module, configured to perform a full-amount red-voiding operation based on the full-amount electronic blue invoice to obtain a remaining paid fee if the refund request is a partial refund, and cancel the full-amount electronic blue invoice; and
a generation module, configured to generate the differential electronic blue invoice based on the remaining paid fee.

16. The device of claim 15, wherein the detection module is further configured to call a preset differential electronic blue invoice generation interface, detect, in the differential electronic blue invoice generation interface, a first generation request for generating the differential electronic blue invoice that corresponds to the refund request, and detect whether there already exists in the differential electronic blue invoice generation interface a second generation request that is not executed;
the apparatus further includes a discarding module configured to discard the second generation request, if the first generation request is detected and the second generation request exists in the differential electronic blue invoice generation interface;
the detection module is further configured to detect, based on the first generation request, whether a red-voiding item corresponding to the full-amount red-voiding operation satisfies preset conditions; and
the apparatus further includes a startup module configured to initiate the process of generating the differential electronic blue invoice if the red-voiding item satisfies the preset conditions.

17. The device of claim 16, wherein the program code further comprises:
an execution prohibition module, configured to prohibit the operation of generating the differential electronic blue invoice based on the remaining paid fee if the first generation request is not detected and the second generation request does not exist in the differential electronic blue invoice generation interface.

18. The device of claim 16, wherein the program code further comprises:
a first acquisition module, configured to, if the first generation request and the second generation request are both detected but the second generation request has been executed, obtain a corresponding blue invoice number of the generated differential electronic blue invoice, and display the blue invoice number.

19. An apparatus for generating a differential electronic blue invoice, the apparatus comprising a memory, a processor, and a differential electronic blue invoice generation program that is stored in the memory and that is operable on the processor, the differential electronic blue invoice generation program when executed by the processor performing the following operations:
in response to detection of a refund request and that a full-amount electronic blue invoice has been generated during payment process, detecting whether the refund request is a partial refund;
if the refund request is a partial refund, performing a full-amount red-voiding operation based on the full-amount electronic blue invoice to obtain a remaining paid fee, and cancelling the full-amount electronic blue invoice; and
generating the differential electronic blue invoice based on the remaining paid fee.

20. (canceled)
